(19) United States
(12) Patent Application Publication
(10) Pub. No.: US 2024/0153008 A1
(43) Pub. Date: May 9, 2024

(54) MANAGEMENT SERVER, PROPERTY MANAGEMENT PROGRAM, AND PROPERTY MANAGEMENT METHOD

(71) Applicant: WealthPark Co., Ltd., Shibuya-ku (JP)

(72) Inventor: Ryuta KAWADA, Shibuya- ku (JP)

(73) Assignee: WealthPark Co., Ltd., Shibuya-ku (JP)

(21) Appl. No.: 18/281,961

(22) PCT Filed: Mar. 15, 2022
(86) PCT No.: PCT/JP2022/011709

§ 371 Date: Sep. 14, 2023

(30) Foreign Application Priority Data
Mar. 16, 2021 (JP) 2021-042892

(51) Int. Cl. G06Q 40/06; G06Q 30/0601

(52) U.S. Cl. CPC G06Q 40/06; G06Q 30/0641

(57) ABSTRACT

A system for making an investment using a profit obtained from a property is provided. Receiving information on a house-rent income amount from an asset management company terminal used by an asset management company; calculating an investable amount based on the information on the house-rent income amount; selecting of an investment product based on the investable amount; and outputting the selected investment product to a user terminal used by a user.

### FIELD OF THE INVENTION

The present invention relates to a management server, a property management program, and a management server thereof.

### BACKGROUND

With respect to the background art on this technical field, there is JP 2017-224207 A (which is hereinafter referred as Patent Document 1). In the Patent Document 1, it is disclosed that “when performing a setting of amount of rent for a house-rent property, an owner of the house who carries out self-management is allowed to easily set the amount of rent by himself/herself, in which the amount of money is not extremely diverged from the other amounts of money of similar properties located in the peripheral area, and simultaneously, the acquisition of the largest profit can be anticipated, by referring to the structure information of the rental property and the subjective evaluation. In addition, when requesting to mediate to rent a his/her house, the owner of the house is allowed to select a real estate agent for mediating the service or a sales staff, respectively, at a level suitable to each property, by managing level information associated with a real estate agent for mediating the service or a sales staff, respectively, by whom a recommendation is made to a customer. Further, it is possible to easily find out a business operator suitable to each property from among a plurality of business operators, by storing information, by rank, on business operators associated with the repairs and the cleaning works necessary for the restoration duty when the render moves from the house (see Summary).”

Further, there is JP 2017-138932 A (which is hereinafter referred as Patent Document 2). In the Patent Document 2, it is disclosed that “an authentication unit 14 for authenticating a user; an authority grant unit 15 for granting a first authority to a system user when he/she is a business operator, and for granting a second authority which is different from the first authority, to a system user when he/she is a customer; a customer information registration unit 16 for registering customer information; a possession information registration unit 17 for registering possession information in which the customer information and a property information are associated with each other; a possession information storage unit 18 for storing the possession information which is registered by the possession information registration unit 17; a page create unit 19 for creating a management Web page for each customer; and a simulation execution unit 20 for executing a simulation according to inputted information are included.”

### PRIOR ART DOCUMENTS

[Patent Document 1] JP 2017-224207 A
[Patent Document 2] JP 2017-138932 A

### SUMMARY OF THE INVENTION

### Problem to be Solved by the Invention

According to the Patent Document 1, a system for managing rental properties is described. In addition, according to the Patent Document 2, a system for executing a simulation to evaluate profitability of an investment property is described. However, in any of these patent documents, no study has been made on a system for making an investment using a profit obtained from a property.

Therefore, the present invention provides a system for making an investment using a profit obtained from a property.

### Means for Solving the Problem

To solve the above-mentioned problems, for example, any one of configurations described in the claims can be applied.

According to the present application, there are a plurality of ways for solving the problems. For example, the present application provides a profit-information-management means for obtaining information on a house-rent income amount from an asset management company terminal used by an asset management company; an investable-amount-calculation means for calculating an investable amount based on the information on the house-rent income amount; an investment-product-management means for selecting an investment product based on the investable amount; and an investment-management means for outputting the selected investment product to a user terminal used by a user.

### Effect of the Invention

According to the present disclosure, it becomes possible to provide a system for making an investment using a profit obtained from a property.

The problems, configurations and effects other than the above will be clarified by the following description of the embodiment.

### BRIEF DESCRIPTION OF THE DRAWINGS

FIG. 1 is an example of a configuration diagram of an entire asset management system 1.

FIG. 2 is an example of a hardware configuration of a management server 101.

FIG. 3 is an example of a hardware configuration of a user terminal 102.

FIG. 4 is an example of a hardware configuration of an asset management company terminal 103.

FIG. 5 is an example of an asset management screen 500.

FIG. 6 is an example of an asset management screen 600 for investment.

FIG. 7 is an example of an investment setting selection screen 700.

FIG. 8 is an example of an investment amount display screen.

FIG. 9 is an example of an investment product selection screen.

FIG. 10 is an example of a display screen about withdrawal amount for investment.

FIG. 11 is an example of an investment record screen managed by an asset management company.

FIG. 12 is an example of a management screen of an asset management company.

FIG. 13 is an example of a registration processing flow 1300.

FIG. 14 is an example of a user investment processing flow 1400.

FIG. 15 is an example of a management-server-investment-management processing flow 1500.

FIG. 16 is an example of a processing flow for calculating an investable amount 1600.

FIG. 17 is an example of a processing flow for selecting an investment product 1700.

FIG. 18 is an example of a processing flow for calculating a transfer amount to an investment account 1800.

FIG. 19 is an example of a processing flow for calculating a transfer amount to an investment account 1900.

FIG. 20 is an example of a processing flow for calculating an investment score 2000.

FIG. 21 is an example of a processing flow for performing a transfer process to an investment account 2100.

FIG. 22 is an example of a user DB 2200.

FIG. 23 is an example of a property management company DB 2300.

FIG. 24 is an example of a property DB 2400.

FIG. 25 is an example of a property facility DB 2500.

FIG. 26 is an example of a room DB 2600.

FIG. 27 is an example of a room facility DB 2700.

FIG. 28 is an example of a property transaction DB 2800.

FIG. 29 is an example of a room/owner association DB 2900.

FIG. 30 is an example of a user account DB 3000.

FIG. 31 is an example of a cash flow DB 3100.

FIG. 32 is an example of a periodic investment DB 3200.

FIG. 33 is an example of a periodic individual setting DB 3300.

FIG. 34 is an example of an investment record setting DB 3400.

FIG. 35 is an example of a transfer DB 3500.

FIG. 36 is an example of an investment project cooperation DB 3600

FIG. 37 is an example of an investment project information 3700.

### DESCRIPTION OF THE PREFERRED EMBODIMENTS

Hereinafter, examples will be described with referring to the attached figures.

### Example 1

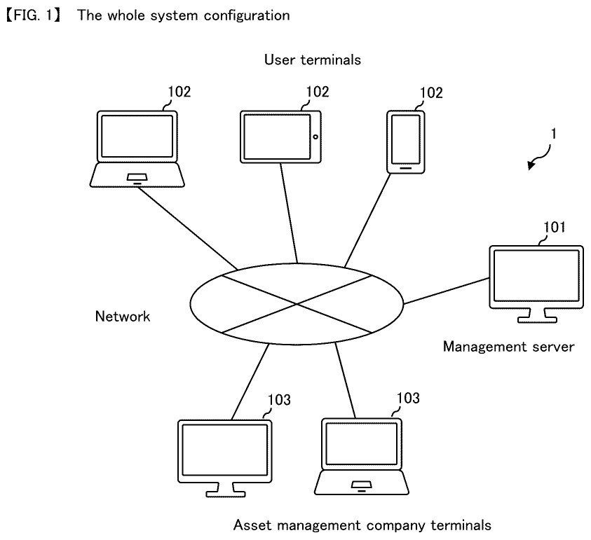

FIG. 1 depicts an example of a configuration of an asset management system 1 as a whole.

The asset management system 1 includes a plurality of user terminals 102 and a plurality of asset management company terminals 103, each of which is connected to a management server 101 via a network. Each terminal is configured to be able to send and receive information over a network regardless of whether the network is wired or wireless.

A user terminal 102 is a terminal used by an owner (or a user) who owns an asset such as real estate for investment.

An asset management company terminal 103 is a terminal used by an asset management company which manages one or a plurality of assets.

For example, each of the terminals and the management server 101 of the asset management system 1 may be configured by a mobile terminal such as a smartphone, a tablet, a mobile phone, or a personal digital assistant (or PDA), or a wearable terminal such as an eyeglass type wearable terminal, a wristwatch type wearable terminal, or a suit (or cloth) type wearable terminal. It may also be a stationary computer, a portable computer, or a server located on a cloud or network. Further, with regard to the function, it may be a VR (or Virtual Reality) terminal, an AR (or Augmented Reality) terminal, or a MR (or Mixed Reality) terminal. Also, it may be any combination of these terminals. For example, a combination of one smartphone and one wearable terminal may logically function as one terminal. Further, it may be any one of other information processing terminals.

Each of the terminals and the management server 101 of the asset management system 1 includes a processor for executing an operating system, an application, and a program, etc.; a main storage device, such a RAM (or Random Access Memory); an auxiliary storage device such as an IC card, a hard disk drive, an SSD (or Solid State Drive), or a flash memory, etc.; a communication control unit, such as a network card, a wireless communication module, or a mobile communication module, etc.; an input device, such as a touch panel, a keyboard, a mouse, a voice input, or an input device based on inputs of detected movements captured by a camera unit; and an output device, such as a monitor or a display, etc. The output device may be a device or a terminal for transmitting information for outputting it to an external monitor, a display, a printer, or an arbitrarily device, etc.

Various programs and applications (for example, modules), etc., are stored in the main storage device, and when a processer executes any one of these programs and applications, each functional element of the whole system is realized. Each module may be implemented by a hardware, for example, by integrating it. Also, each module may be an independent program or application. Further, each module may be implemented in a form of a sub-program or function included in an integrated program or application.

In this specification, each module is described as an entity (or a subject) for performing processes, but in practice, a processor for performing various programs and applications (for example, modules) executes the processes.

Various databases (or DB) are stored in the auxiliary storage device. A “database” is a functional element (or storage unit) for storing data sets so as to correspond to data manipulations (for example, extracting, adding, deleting, and/or overwriting data, etc., which are executed by a processor or an external computer. The method for implementing the databases is not limited, and may be, for example, a database management system, a spreadsheet software or a text file such as XML, or JSON, etc.

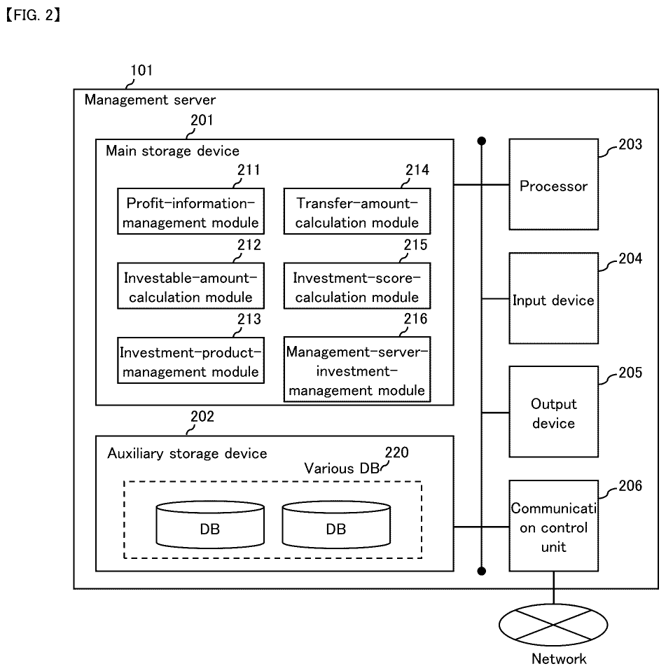

FIG. 2 depicts an example of a hardware configuration of a management server 101. For example, the management server 101 is configured by a server provided on a cloud. A main storage device 201 is provided to store various programs and/or applications such as a profit-information-management module 211, an investable-amount-calculation module 212, an investment-product-management module 213, a transfer-amount-calculation module 214, an investment-score-calculation module 215, and a management-server-investment-management module 216. When a processer 203 executes any one of these programs and applications, each functional element of the management server 101 is realized.

The profit-information-management module 211 obtains profit information on an asset(s) owned by an owner(s), such as real estate or the like, from asset management company terminals 103 of a plurality of asset management companies, and manages the information.

The investable-amount-calculation module 212 calculates an investable amount (or investable amount of money) based on the profit information such as a collected house-rent income amount (or amount of money obtained from a house-rent).

The investment-product-management module 213 selects an investment product(s) which is capable of being purchased from an owner, based on the calculated investable amount, and recommends the selection to a user terminal 102.

The transfer-amount-calculation module 214 decides an asset management company from which its profit information is used to pay a purchase amount of an investment product which is desired to be purchased by an owner, calculates a transfer amount (or amount of money to be transferred) to an investment account for each asset management company, and notifies it to each asset management company.

The investment-score-calculation module 215 calculates an investment score for indicating an owner's adaptability for investment, based on a content of a property(s) owned by an owner, or an investment(s) made by an owner in past times. The investment score is obtained as a sum of each scoring (or score) with regard to a property owned by an owner or an investment made by an owner in past times. Basically, as a profitability of a property owned by an owner becomes higher, its score becomes higher. Also, as a purchase frequency of investment property(s) becomes higher, its score becomes higher to indicate that the owner is accustomed to the investment.

The management-server-investment-management module 216 performs processing of the investment management of the management server 101 in cooperation with the profit-information-management module 211, the investable-amount-calculation module 212, the investment-product-management module 213, the transfer-amount-calculation module 214, and the investment-score-calculation module 215.

An auxiliary storage device 202 is provided to store various DB 220.

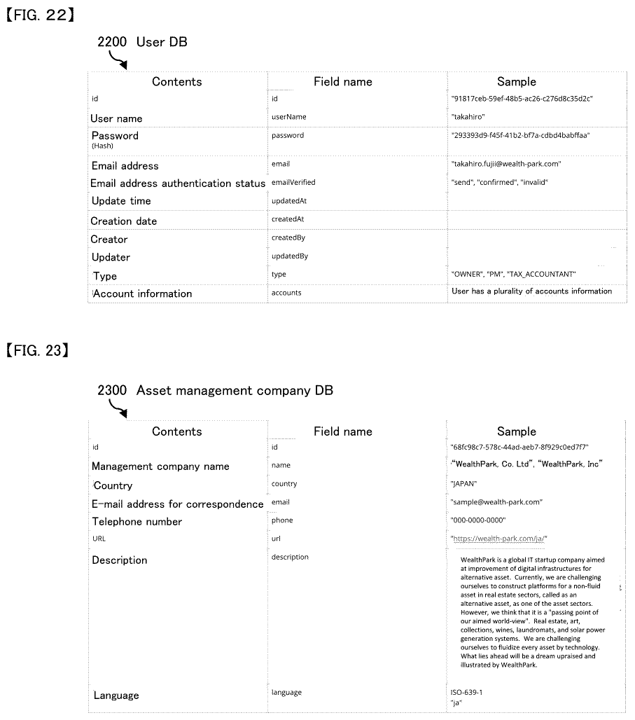

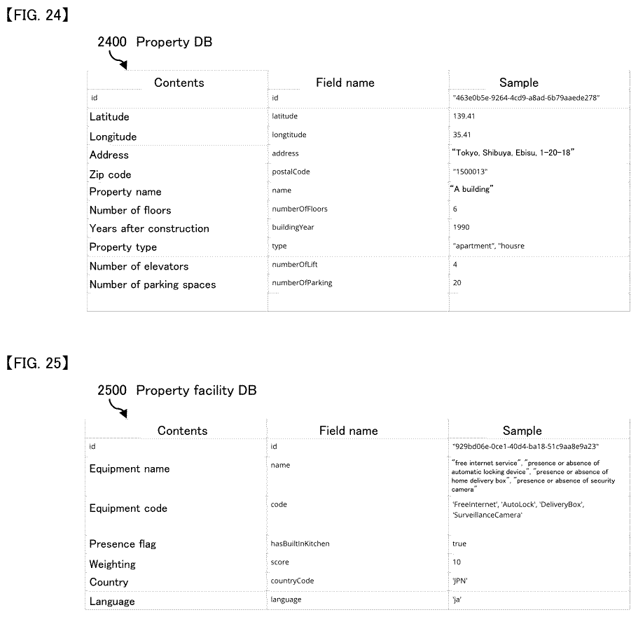

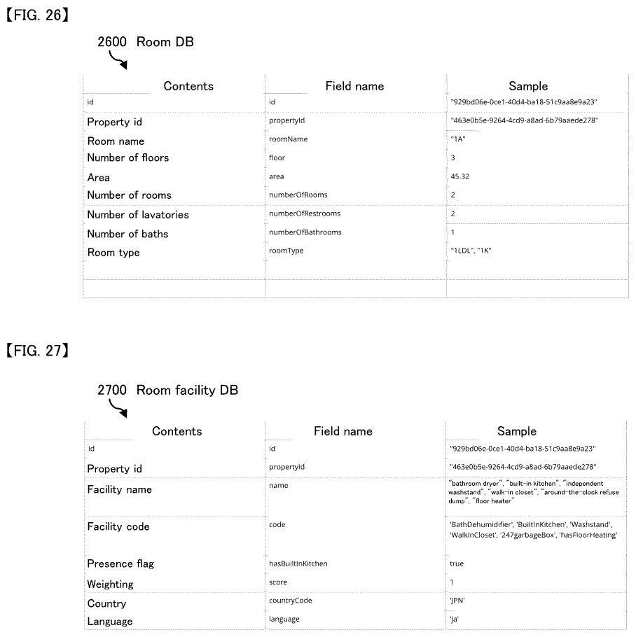

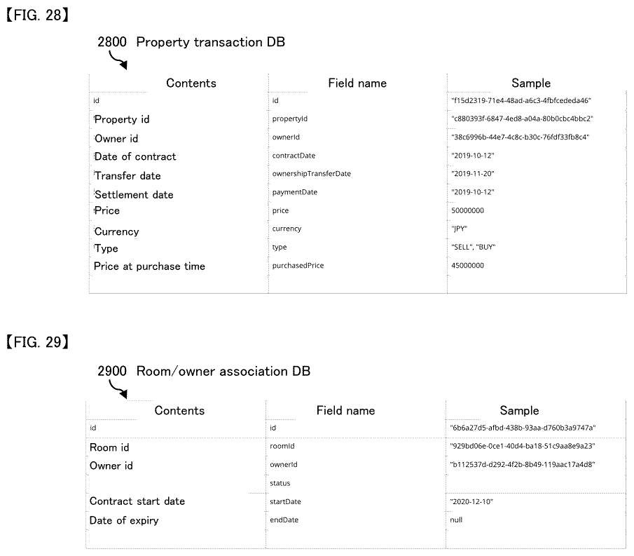

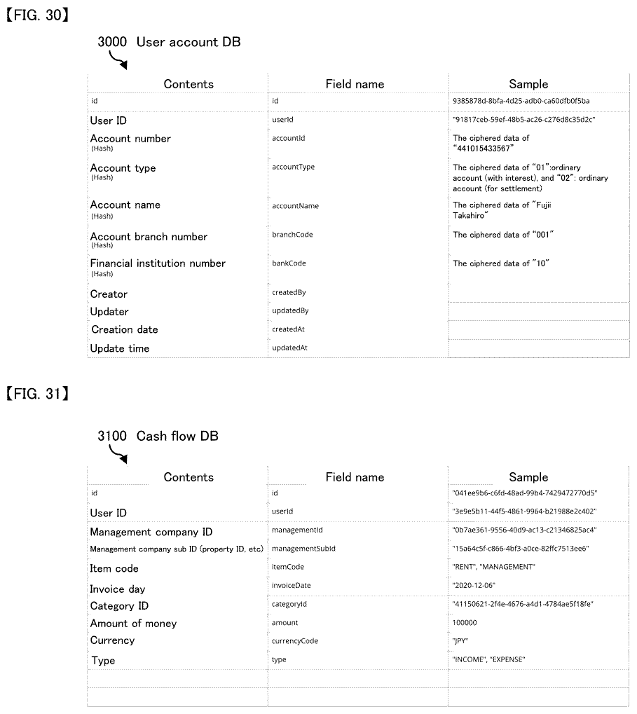

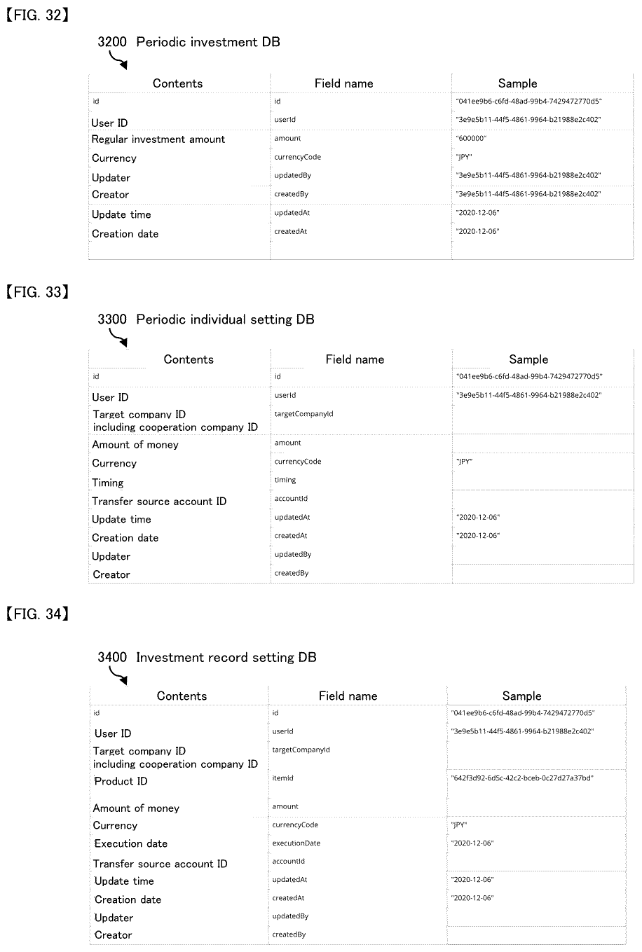

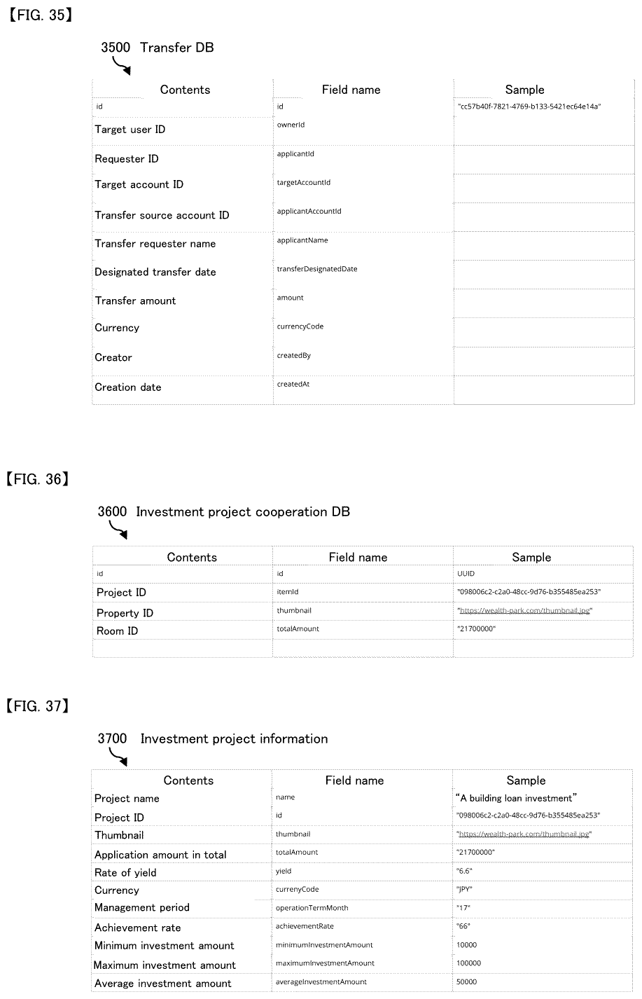

The various DB 220 store various data bases (DB) as depicted in FIGS. 22 to 37, etc. These may be implemented by using a database management system such as a relational database, etc. Also, these may be implemented by using a spreadsheet software or a text file such as XML or JSON, etc.

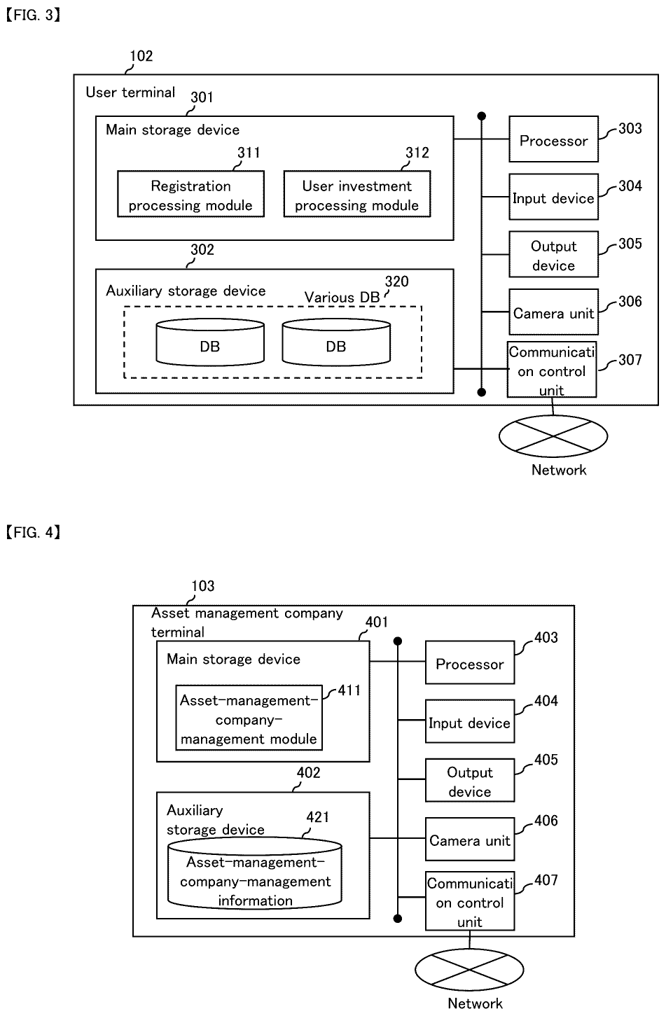

FIG. 3 depicts an example of a hardware configuration of a user terminal 102.

For example, the user terminal 102 may be configured by an arbitrary terminal such as a smart phone, a tablet, a notebook PC, a desktop PC or the like.

A main storage device 301 is provided to store programs and applications, such as a registration-processing module 311 and a user-investment-processing module 312. When a processer 303 executes any one of these programs and applications, each functional element of the user terminal 102 is realized.

The registration-processing module 311 performs a process of registering user information, account information, property information, and investment information, and the like.

The user-investment-processing module 312 connects to the management server 101 and displays, on an output device (for example, on a screen) 305 of the user terminal 102, various information which is collected and/or calculated by the profit-information-management module 211, the investable-amount-calculation module 212, the investment-product-management module 213, the transfer-amount-calculation module 214, and/or the investment-score-calculation module 215 of the management server 101.

In the present example, it is explained that the management server 101 is configured to have the profit-information-management module 211, the investable-amount-calculation module 212, the investment-product-management module 213, the transfer-amount-calculation module 214, and the investment-score-calculation module 215. However, functions similar to those of the above-mentioned modules may be performed by the user-investment-processing module 312 which is executed by the user terminal 102. In this case, the user-investment-processing module 312 performs processing in cooperation with sub modules such as a profit-information-display module, an investable-amount-display module, an investment-product-display module, a transfer-amount-display module, and an investment-score-display module, etc., each of which performs a process corresponding to each module of the management server 101 provided in the user terminal 102.

An auxiliary storage device 302 is provided to store various DB 320.

The various DB 320 store owner's profit information, property information, asset management company information, investment information, and the like which are managed by the user terminal 102.

FIG. 4 depicts an example of a hardware configuration of an asset management company terminal 103.

For example, the asset management company terminal 103 may be configured by a terminal such as a smart phone, a tablet, a notebook PC, or a desktop PC, etc.

A main storage device 301 is provided to store programs and applications such as an asset-management-company-management module 411. When a processer 403 performs any one of the programs and applications, each functional element of the asset management company terminal 103 is realized.

The asset-management-company-management module 411 transmits profit information on incomings and outgoings associated with a property, such as a house-rent income amount which is a sum of an owner's income amount obtained from a house-rent of a property and administrative costs thereof, managed by an asset management company, to the management server 101 for sharing it.

Also, it performs a process of distributing all or a part of the owner's house-rent income amount to the owner's investment account, in accordance with an investment-account transfer amount (or an amount of money to be transferred to an investment account) which is notified from the transfer-amount-calculation module 214 of the management server 101.

An auxiliary storage device 402 is provided to store asset-management-company-management information 421.

The asset-management-company-management information 421 stores profit information, property information, and investment information, etc., of a plurality of owners which are managed by an asset management company.

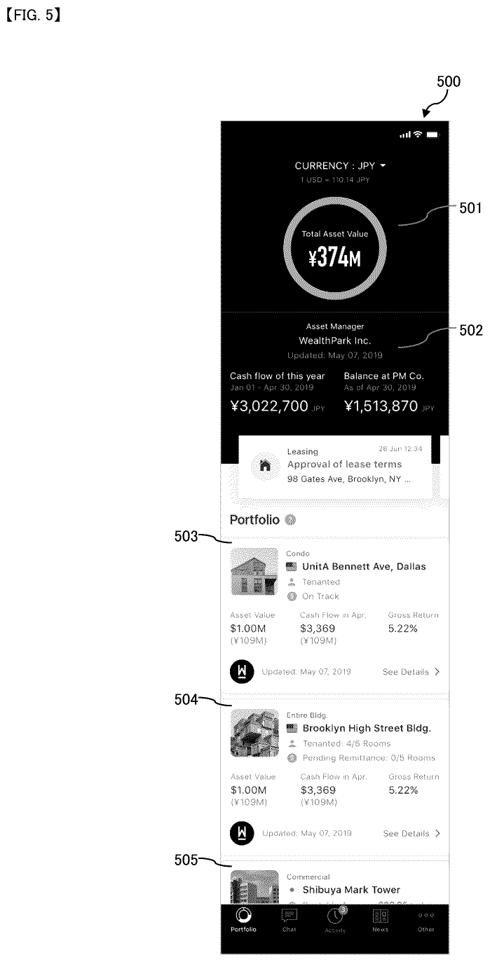

FIG. 5 depicts an example of an asset management screen 500.

The user-investment-processing module 312 of the user terminal 102 is capable of displaying information about a plurality of assets 503 owned by an owner collectively on the asset management screen 500, based on either one of information managed by the user terminal 102, or information which is collected by the profit-information-management module 211 of the management server 101 and is notified from the management server 101.

A present value 501 which is a sum of a plurality of assets 503, 504, and 505, etc., and/or asset information 502 such as a cash flow are aggregated and displayed by the user-investment-processing module 312.

FIG. 6 depicts an example of an asset management screen 600 for investment.

The user-investment-processing module 312 displays a monthly cash flow 601 and/or a monthly house-rent income amount 602 which is calculated based on a house-rent income amount, an expenditure, and a loan repayment, according to information received from the management server 101.

Also, the user-investment-processing module 312 displays a setting 605 for regular investment which is made continuously at regular times according to the monthly house-rent income amount.

Further, the user-investment-processing module 312 displays an investment score 606 which is calculated by the investment-score-calculation module 215 of the management server 101, and displays an available amount (or available amount of money) 604 from house-rent in advance which may vary according to the investment score 606. The owner is capable of making a loan by borrowing money from house-rent in advance 603 by drawing a house-rent in advance up to the available amount 604 for making an investment.

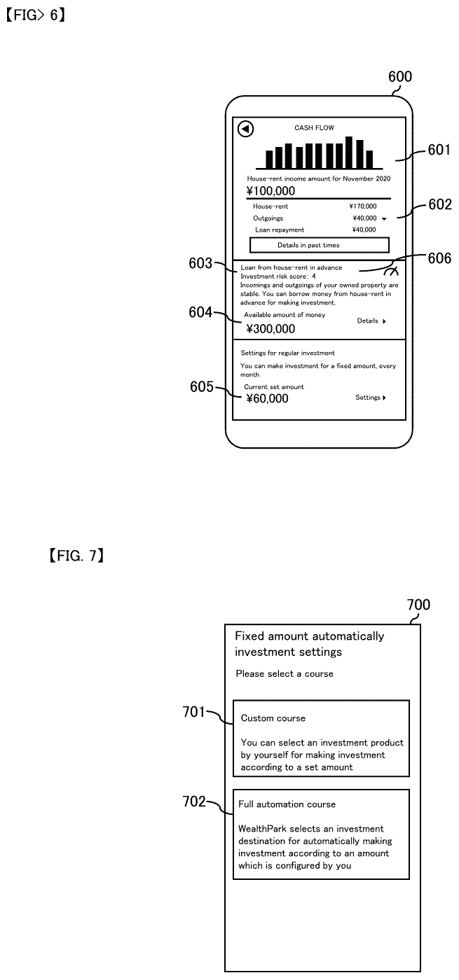

FIG. 7 depicts an example of an investment setting selection screen 700.

The user-investment-processing module 312 displays either one of a custom course 701 in which an owner is allowed to select an investment product by himself/herself to make an investment, and a full automation course 702 in which the management server 101 selects an investment target automatically with respect to a set amount of money. Either of the custom course 701 and the full automation course 702 is shown in a selectable form.

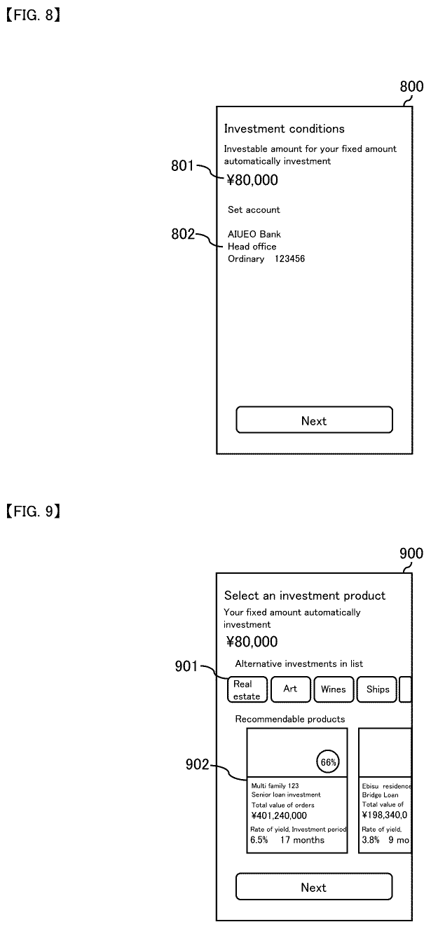

FIG. 8 depicts an example of an investment amount display screen.

The user-investment-processing module 312 obtains information on an owner's investable amount for making an investment which is calculated by the investable-amount-calculation module 212, from the management server 101, and display the investable amount 801.

Also, it displays information on an owner's investment account 802 which is registered by the registration-processing module 311. The information on the investment account 802 is obtained from the user account DB 3000 stored in the user terminal 102 or the management server 101, for displaying it.

FIG. 9 depicts an example of an investment product selection screen.

FIG. 9 and after correspond to display screens when the custom course 701 is selected by a user. The user-investment-processing module 312 displays one or a plurality of categories of investment target(s) 901 belonging to alternative investment which is capable of being invested as an investment destination. The alternative investment is not limited to properties of real estate, but may include art, wines, ships, and other kinds of investment targets which are capable of being purchased by an owner. These investment targets may be displayed in a list.

Upon receiving a selection of a category of investment target 901 from an owner, the user-investment-processing module 312 displays one or a plurality of investment products 902 associated with the selected category of investment target 901, in a list.

Upon receiving a selection of an investment product 902 from an owner, the user-investment-processing module 312 may display details of it and may perform a purchase process.

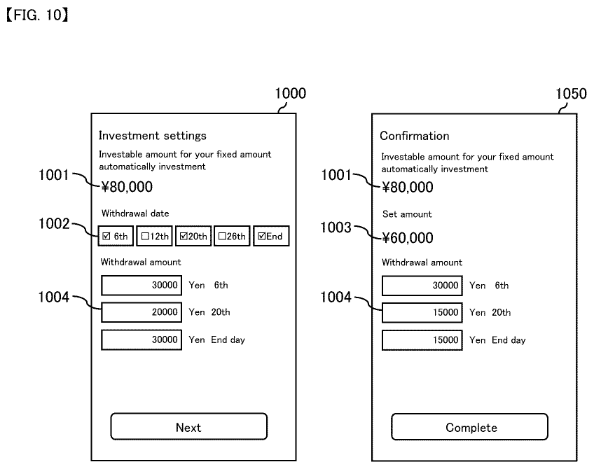

FIG. 10 depicts an example of a display screen about withdrawal amount for investment. The user-investment-processing module 312 displays an investable amount 1001 so that an owner is allowed to set a withdrawal amount 1004 within this amount of money. The user-investment-processing module 312 calculates a total amount of money about the withdrawal amount 1004, and displays it as the set amount of money 1003.

Also, the user-investment-processing module 312 displays one or a plurality of debit dates 1002 in a selectable form so that an owner is allowed to set a debit date and a debit amount.

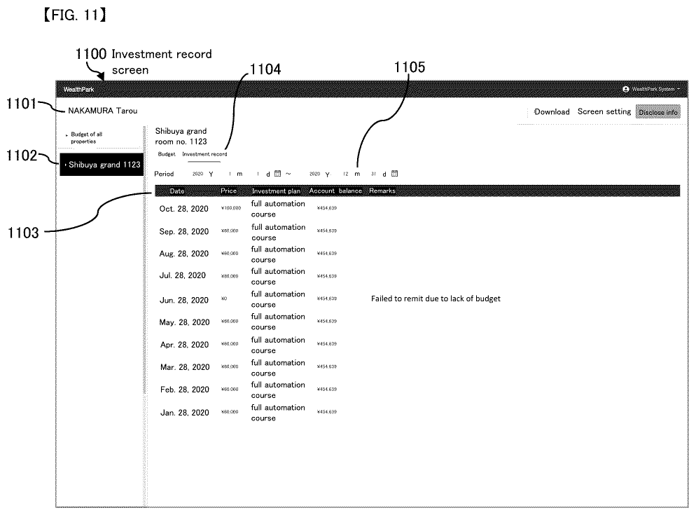

FIG. 11 depicts an example of an investment record screen which is managed by the asset management company.

Upon receiving a selection of an investment record display 1104, the asset management company terminal 103 displays an investment record 1103 which is executed within a specified period 1105 for each property 1102 which is owned by the owner 1101. The investment record 1103 has items such as an investment execution date, an amount of money or price, an investment target or plan, a balance in the investment account, and remarks. When any of these items is selected, further details about the investment may be displayed.

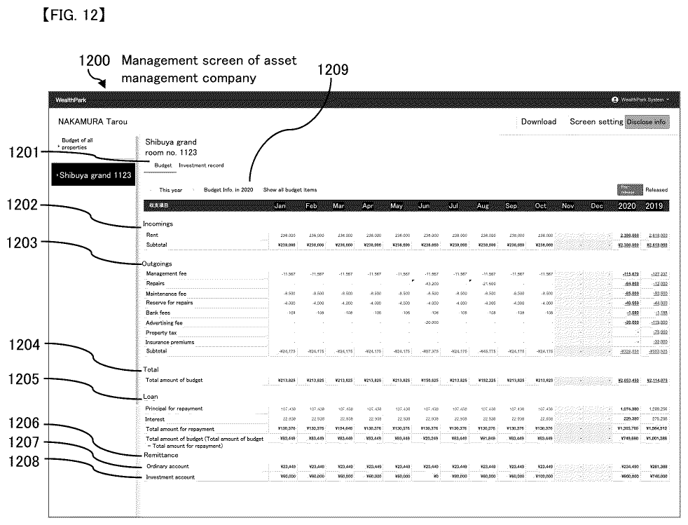

FIG. 12 depicts an example of a management screen of an asset management company. Upon receiving a selection of a balance display 1201, the asset management company terminal 103 displays balance information in a range of a specified period 1209 for each property owned by the owner.

The asset-management-company-management module 411 displays incomings 1202 such as a house-rent income amount obtained from a property. The house-rent income amount is a sum of an amount of rent to be paid by the renter and the management costs thereof.

The asset-management-company-management module 411 displays outgoings 1203 such as the management costs, and the like. The necessary outgoings are registered by the asset management company.

The asset-management-company-management module 411 calculates a difference between the incomings 1202 and the outgoings 1203 and displays the result as the total amount 1204 of the incomings and the outgoings (or budget).

The asset-management-company-management module 411 displays a loan 1205 of borrowings. Information on a loan may be registered by the owner through the registration-processing module 311 of the user terminal 102. Alternatively, information on a loan may be obtained and displayed by the profit-information-management module 211 of the management server 101 or by the asset-management-company-management module 411 of the asset management company terminal 103, in cooperation with the bank API, based on information included in the user account DB 3000 registered by the registration-processing module 311.

The asset-management-company-management module 411 calculates a remittance amount 1206 to be remitted to the owner, by deducting (or subtracting) the amount of the loan 1205 from the total amount 1204

If the asset management company does not perform an acting payment processing of the loan, an amount of money which is calculated by deducting the management costs (as outgoings) from the house-rent income amount is remitted to the owner.

The asset-management-company-management module 411 displays the remittance amount 1206 directed to the owner to whom the house-rent income amount is transferred. As for the transfer destinations of the remittance amount 1206, there may be an ordinary account (or ordinary deposit account) 1207 to which an ordinary house-rent income amount is transferred, and an investment account 1208 from which a purchase amount of an investment product is withdrawn.

The asset-management-company-management module 411 transfers a part of the house-rent income amount to the investment account 1208 according to the investment-account transfer amount which is calculated by the transfer-amount-calculation module 214 of the management server 101, and transfers the remaining amount of money to the ordinary account 1207.

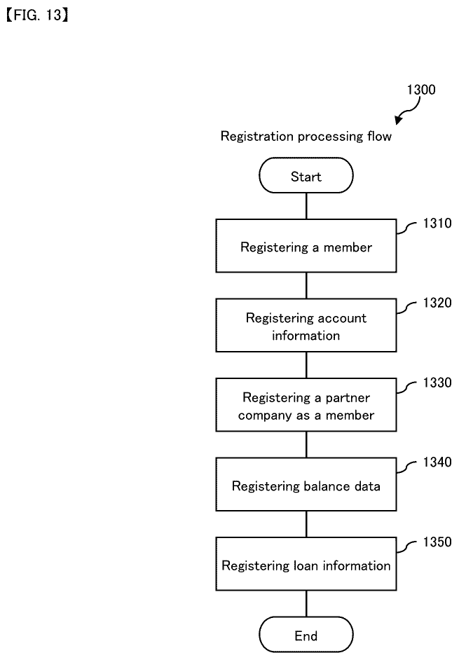

FIGS. 13 to 21 depict examples of various processing flows which are executed by the management server 101, the user terminal 102, and/or the asset management company terminal 103.

FIG. 13 depicts an example of a registration processing flow 1300.

The registration processing flow 1300 is a flow in which the registration-processing module 311 of the user terminal 102 registers various information so that an owner is allowed to make an investment.

The registration-processing module 311 registers membership information of an owner who is an investor, in the user DB 2200 of the management server 101 (step 1310).

The registration-processing module 311 registers account information such as the owner's bank, in the user account DB 3000 of the management server 101 (step 1320).

The registration-processing module 311 registers information about an asset management company which manages a property owned by an owner, to the asset management company DB 2300 of the management server 101 (step 1330).

The registration-processing module 311 registers information about a balance (or budget) of the property (step 1340).

Also, the registration-processing module 311 registers information about a loan in the cash flow DB 3100 of the management server 101 (step 1350).

It is also possible to store various types of DB stored in the management server 101 in the user terminal 102.

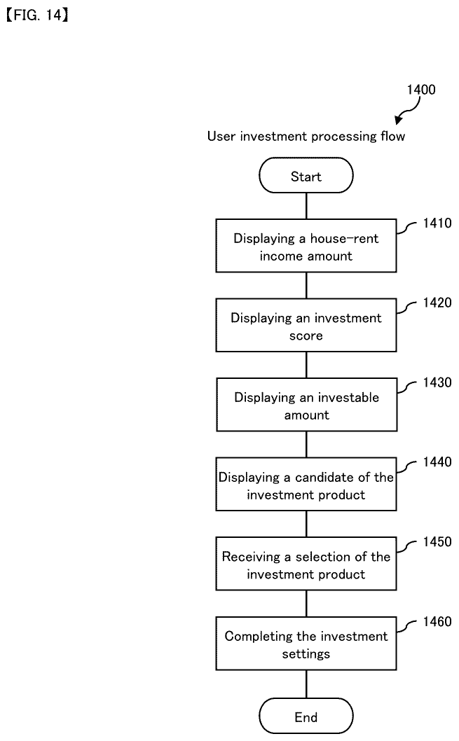

FIG. 14 depicts an example of a user investment processing flow 1400.

The user investment processing flow 1400 is a flow in which the user-investment-processing module 312 of the user terminal 102 performs a process of purchasing an investment product.

The user-investment-processing module 312 displays a house-rent income amount of a property which is owned by an owner, received from the management server 101, on a screen as depicted in FIG. 6 (step 1410).

The user-investment-processing module 312 receives information about an investment score which is calculated by the investment-score-calculation module 215 of the management server 101, and displays the investment score 606 (step 1420).

The user-investment-processing module 312 receives information about an investable amount of an owner which is calculated by the investable-amount-calculation module 212 of the management server 101, and displays the investable amount on a screen, for example, as depicted in FIGS. 8 to 10 (step 1430).

The user-investment-processing module 312 obtains information about one or a plurality of candidates of the investment product selected by the investment-product-management module 213 of the management server 101, and displays the results on a screen, for example, as depicted in FIG. 9 (step 1440).

The user-investment-processing module 312 receives a selection from an owner who desires to purchase an investment product (step 1450), and receives an input of necessary information to complete the investment setting with regard to the investment product to be purchased (step 1460).

The investment setting stores a setting for performing the purchase process of the investment product and for withdrawing the purchase amount from the investment account. The user-investment-processing module 312 connects with a terminal of an investment product selling company which sells the investment product to be purchased, via the API or the like, and notifies the content of the investment setting to the investment product selling company. Alternatively, the user-investment-processing module 312 may connect with the terminal of the investment product selling company for performing the purchase process directly.

In the present example, it is explained that the user terminal 102 performs the purchase process of the investment product. However, the management-server-investment-management module 216 of the management server 101 may perform the purchase process based on the selection of the investment product which is received by the user-investment-processing module 312.

Also, in the present example, the user terminal 102 performs the purchase process of the investment product, and the transfer-amount-calculation module 214 of the management server 101 calculates the investment-account transfer amount by the withdrawal date of the investment account for the purchase amount, and notifies the amount of money to the asset management company terminal 103. Then, the asset management company deposits all or a part of the house-rent income amount to the investment account.

However, the management server 101 and the asset management company terminal 103 may mutually cooperate, whereby the management server 101 may perform the purchase process of the investment product with regard to the investment product selling company, and the asset management company terminal 103 may perform the transfer process of the purchase amount to the investment product selling company.

Also, the user terminal 102 and the asset management company terminal 103 may mutually cooperate, whereby the user terminal 102 may perform the purchase process of the investment product with regard to the investment product selling company, and the asset management company terminal 103 may perform the transfer process of the purchase amount to the investment product selling company.

Also, the user terminal 102, the management server 101, and the asset management company terminal 103 may mutually cooperate, whereby the user terminal 102 may perform the purchase process of the investment product with regard to the investment product selling company and notify the content thereof to the management server 101, the management server 101 may calculate the transfer amount and select the asset management company for performing the transfer process, and the selected asset management company terminal 103 may perform the transfer process of the purchase amount to the investment product selling company.

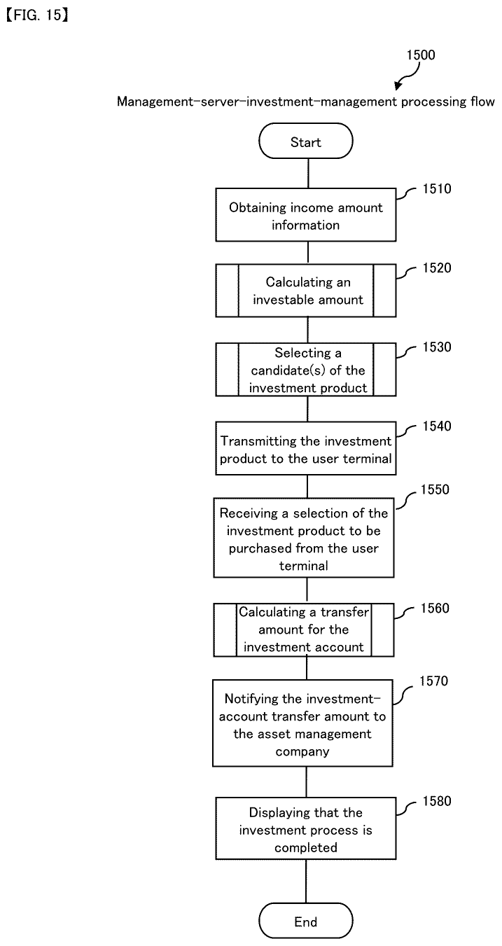

FIG. 15 depicts an example of a management-server-investment-management processing flow 1500.

The management-server-investment-management processing flow 1500 is a processing flow in which the management-server-investment-management module 216 of the management server 101 proposes an investment product(s) to the user terminal 102 based on a house-rent income amount and receives the investment.

The management-server-investment-management module 216 obtains information on a house-rent income amount from the asset management company terminal 103 through the profit-information-management module 211 (step 1510).

Specifically, the profit-information-management module 211 periodically obtains information on an income amount of house-rent obtained from a property(s) owned by an owner from a plurality of the asset management company terminals 103, and stores them in a cash flow DB 3100. Further, the profit-information-management module 211 obtains information on a payment such as management costs and various expenses from the user terminal 102 and also information on a loan or the like if registered, and stores them in the cash flow DB 3100.

The profit-information-management module 211 may obtain cash flows of all or a selected part of properties owned by a specific owner and the sum of incomings and outgoings thereof, based on information about incomings and outgoings stored in the cash flow DB 3100, and may display them.

The management-server-investment-management module 216 obtains the investable amount with regard to the owner from the investable-amount-calculation module 212 (step 1520). The investable-amount-calculation module 212 calculates the investable amount according to the information on the house-rent income amount as described below.

Also, the management-server-investment-management module 216 selects candidates of a plurality of investment products which are selected according to the investable amount, through the investment-product-management module 213 (step 1530).

The management-server-investment-management module 216 transmits information of the selected investment products as recommendable products to the user terminal 102 (step 1540).

Thereafter, the management-server-investment-management module 216 obtains information on the investment product which is selected by the owner for purchasing it (step 1550).

Also, the management-server-investment-management module 216 cooperates with the transfer-amount-calculation module 214 to calculate an investment-account transfer amount according to the information on the investment product to be purchased which is received from the user terminal 102 (step 1560).

The management-server-investment-management module 216 transmits information about the calculated investment-account transfer amount to the asset management company terminal 103 (step 1570).

Once the above-mentioned series of processing are completed, the management-server-investment-management module 216 performs a process of displaying in order to indicate that the investment process is completed (step 1580).

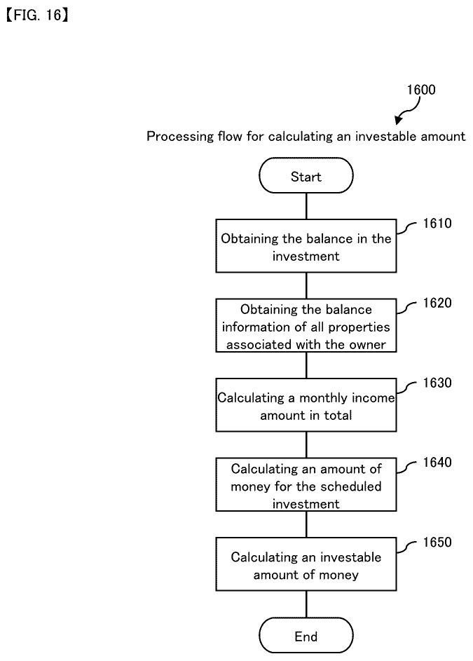

FIG. 16 depicts an example of a processing flow for calculating an investable amount 1600.

The processing flow for calculating an investable amount 1600 is a processing flow in which the investable-amount-calculation module of the management server 101 calculates an investable amount according to the information on the house-rent income amount.

The investable-amount-calculation module 212 obtains the balance in the investment account based on the information in the user account DB 3000 (step 1610).

The investable-amount-calculation module 212 obtains balance information (or budget information) of all properties associated with a specific owner which is obtained from the profit-information-management module 211 (step 1620).

The investable-amount-calculation module 212 calculates a monthly income amount in total, by adding the balance in the investment account to a sum of monthly income amounts obtained from a plurality of properties (step 1630).

The investable-amount-calculation module 212 obtains the information on an amount of money about the owner's monthly periodic investment, from the periodic investment DB 3200 and the periodic individual setting DB 3300, and then calculates an amount of money for the scheduled investment, as the sum of these values (step 1640).

The investable-amount-calculation module 212 calculates an investable amount, by deducting the amount of money for the scheduled investment from the monthly income amount in total (step 1650).

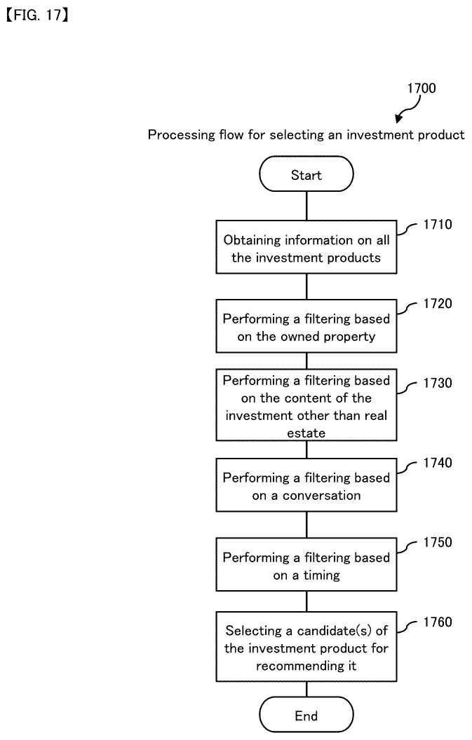

FIG. 17 depicts an example of a processing flow for selecting an investment product 1700. The processing flow for selecting an investment product 1700 is a processing flow in which the investment-product-management module 213 makes a selection of an investment product(s) which is recommended to an owner based on the investable amount.

The investment-product-management module 213 obtains investment project information 3700 provided by an external partner investment product selling company(s), investment project information 3700 stored in the management server 101, and information on all the investment products (step 1710).

The investment project information 3700 may be obtained by the investment-product-management module 213 from another investment product selling company(s) through the API (or Application Programming Interface). However, in a case where enough information on a property and/or room is not included in the investment project, it may obtain property information by cooperating with the property DB 2400 and room DB 2600 of the management server 101 from the investment project cooperation DB 3600. Also, the manager may input the corresponding content with regard to the investment project information 3700.

The investment-product-management module 213 performs a filtering based on the property(s) owned by the owner from all the investment products (step 1720).

Specifically, the investment-product-management module 213 obtains information on all the properties owned by the owner from the property DB 2400, the room DB 2600, the property transaction DB 2800, the room/owner association DB 2900, and the like, and obtains information on the unit price, the rate of yield, the type, the room area, the address, and the years after construction, etc., of the property or room which is owned by the owner.

The investment-product-management module 213 narrows down the recommendable investment products of real estate, based on the data about an acceptable level of the property(s) or room owned by the owner or a trend of the property(s) of preference.

The investment-product-management module 213 analyzes the information on the property and/or room owned by the owner to calculate or obtain the preferred region, the preferred unit price of the property, the preferred room type, the rate of yield, and the years after construction, and narrows down investment properties of real estate that meet these preferred property conditions.

For example, the investment-product-management module 213 performs the narrowing of data based on the preferred area. For example, in a case where two or more properties are owned by an owner in a specific area, then, the investment-product-management module 213 may select the area as the preferred area. It is possible to perform the analysis by categorizing regions variously. For example, regions may be classified into categories such as each of the prefectures, the regions (for example, Kinki region of Japan), the urban areas, the tourist areas, the economic zones such as regions or the like. The investment-product-management module 213 may set a category in which a large number of properties are owned by an owner as the preferred area, on the basis of the category to which the owned properties belong to.

Also, for example, the investment-product-management module 213 may perform the narrowing of data based on the preferred unit price of the property. For example, in a case where two or more properties belonging to the same price range are owned by an owner, the investment-product-management module 213 may select the price range as the preferred price range of the property.

Also, for example, the investment-product-management module 213 may perform the narrowing of data based on the preferred room type. For example, in a case where two or more rooms belonging to the similar room type are owned by an owner, the investment-product-management module 213 may select the room type, as the preferred room type.

Also, for example, the investment-product-management module 213 may calculate the average rate of yield and the average years after construction of a plurality of properties owned by an owner, and may select the results, as the preferred property conditions.

Also, for example, the investment-product-management module 213 may calculate the minimum rate of yield of a plurality of properties owned by an owner, and may select the rate which is equal to or higher than the obtained numeric value, as the preferred property condition.

Also, for example, the investment-product-management module 213 may calculate the lowest years after construction and the highest years after construction of a plurality of properties owned by an owner, and may select the intermediate years after construction that falls between the two, as the preferred property condition.

The investment-product-management module 213 may narrow down the investment properties meeting one or a plurality of the preferred property conditions which are obtained as described above.

The investment-product-management module 213 performs a filtering based on the content of the investment (which is other than real estate) in past times, from all investment properties (step 1730).

The investment-product-management module 213 obtains an investment record stored in the management server 101 and/or information on the investment data obtained from a cooperative company (or partner company) through the API or the data cooperation.

For example, the investment-product-management module 213 may perform the narrowing of information based on the preference category. For example, in a case where two or more investment properties belonging to a particular category are owned by an owner, the investment-product-management module 213 may select the category as the preferred category of the investment product.

As the categories of the investment products other than real estate, for example, there may be wines, art, ships, luxury cars, acing horses, and the like.

The investment-product-management module 213 may preferentially display the information about a cooperative company which sells and displays the investment products belonging to the preferred category.

For example, the investment-product-management module 213 may calculate the average rate of yield, the average investment amount, and the average investment interval with regard to a plurality of investment properties owned by an owner, and may select the results as the preferred conditions of the investment product.

Also, for example, the investment-product-management module 213 may calculate the minimum rate of yield for a plurality of investment properties owned by an owner, and may select the numeric value which is equal to or higher than the result, as the preferred condition of the investment product.

Also, for example, the investment-product-management module 213 may calculate the minimum investment amount and the maximum investment amount of a plurality of investment properties owned by an owner, and may select the amount of money that falls between the two, as the preferred condition of the investment product.

The investment-product-management module 213 may perform the narrowing of investment products (which are other than real estate) satisfying one or a plurality of the preferred conditions of the investment products, as described above.

However, it is possible to perform the above-mentioned processing of the narrowing of investment products, especially for the investment products including real estate, according to the categories and/or the conditions of investment products.

Also, the investment-product-management module 213 may calculate scores of recommendable investments, and then, may extract a recommendable investment(s) having a higher score(s), by performing the narrowing of the investment products according to the scores.

For example, the score of the recommendable investment may be obtained from the following equation (the full score is 100 points).

(100−|Average investment amount of target product−Average investment amount|×100/MAX (Average investment amount, Average investment amount of target product)+100-|Rate of yield of target product−Average rate of yield|×100/MAX(Average investment amount, Average investment amount of target product)/2

The investment-product-management module 213 may perform a filtering based on a content of a conversation, for all the investment products (step 1740).

The investment-product-management module 213 may obtain a record of a chat conversation or the like performed between the user terminal 102 and the management server 101 and/or the asset management company terminal 103.

The investment-product-management module 213 may extract specific keywords (for example, a word indicating an investment category or a word indicating a desire to buy), by performing a natural language processing on a record of a chat conversation.

For example, during the course of the processing of the natural language extraction, some keywords are extracted from the following three points of view.

That is, words indicating a product category such as “wine”, “art”, “real estate”, “building” or the like may be extracted.

Also, words indicating a desire to buy such as “want to purchase,” “want to buy,” and “want to invest” or the like may be extracted.

Also, words indicating a desire to sell such as “want to sell”, “sell” and “interest” or the like may be extracted.

Then, the investment-product-management module 213 may narrow down the investment products associated with the keywords, according to the extracted specific keywords.

The investment-product-management module 213 may perform a process of a filtering based on a timing, for all the investment products (step 1750).

The investment-product-management module 213 may obtain the tenant information, the loan information, and the investment record which are stored in the management server 101 to calculate an investment interest period (or a period of time during which an interest in investment is maintained) based on these information, as a period during which the investment product is likely to be purchased.

Element 1: A flag indicating that a property is possessed for a long term. If a property is possessed for 10 years or more, then, the condition is designated as an interest period.

Element 2: A time of full repayment of loan: A period of one year immediately before and after the timing of full repayment of each loan is designated as an investment interest period.

Element 3: When the following relationship of: [Assessed amount of money of property (or room)−Loan balance>10 million Japanese yen] is satisfied for a specific property or room, then the condition is designated as an investment interest period.

Element 4: A departure of a tenant: A period of three months immediately before and after the timing of a departure of a tenant is designated as an investment interest period.

Element 5: A decision on tenant occupation: A period of one month immediately after the timing of the decision on tenant occupation is designated as an investment interest period.

If any of the above-mentioned elements 1 to 5 is satisfied, that is selected as an investment interest period, and then the investment products which are capable of being purchased during the investment interest period are narrowed down.

The investment-product-management module 213 selects candidates of recommendable investment products according to the following order, with regard to the investment products which are filtered by the steps from step 1720 to step 1750.

That is, the recommendable investment products are narrowed down in the below order.
Sort 1: Product(s) matched with all the filtering (conditions).
Sort 2: Product(s) matched with two or more of the filtering.
Sort 3: Product(s) matched with one of the filtering.
Sort 4: Product(s) recommended by the management server 101.

The filtering performed based on the timing may be used not only for narrowing down the investment products but also for determining a timing to notify the recommendable investment product(s) to the user terminal 102.

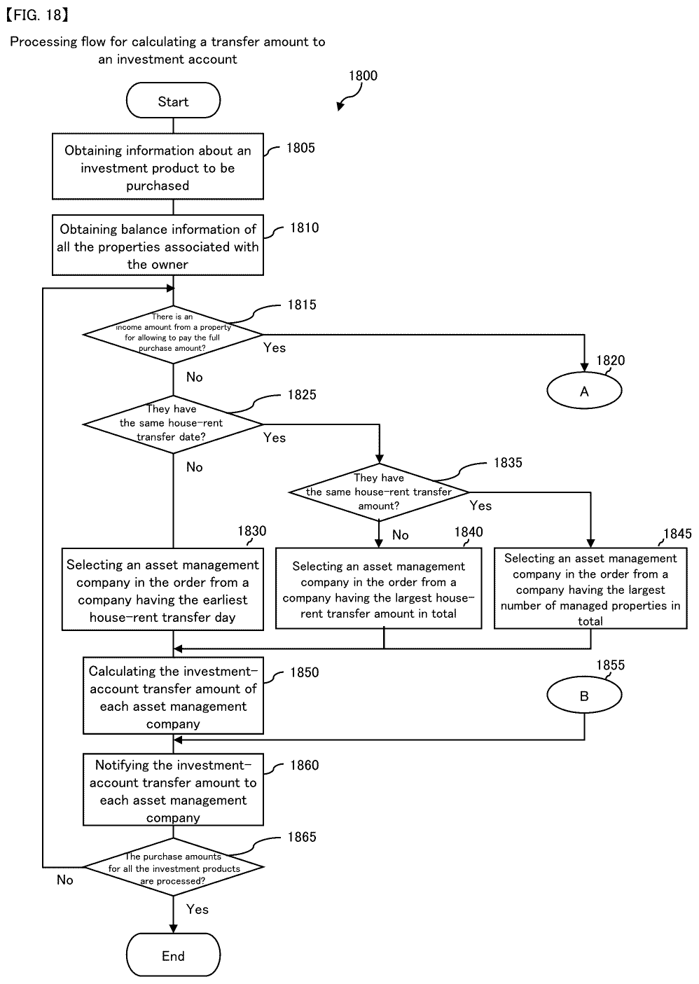

FIG. 18 depicts an example of a processing flow for calculating a transfer amount to an investment account 1800.

The processing flow for calculating a transfer amount to an investment account 1800 is a processing flow in which the transfer-amount-calculation module 214 calculates an amount of money to be transferred to the investment account of the owner, based on the amount of money of the investment product which is selected by the owner for purchasing it, and decides the asset management company for performing the transferring processing.

The transfer-amount-calculation module 214 obtains investment product information about the investment product which is selected by the owner for purchasing it, from the user terminal 102 (step 1805).

The transfer-amount-calculation module 214 obtains balance information of all the properties associated with the owner (step 1810).

In a case where there is an income amount from a property which can cover (or pay) an entire amount of the purchase amount (“Yes” in step 1815), then it proceeds to a processing flow depicted in FIG. 19 (step 1820).

In a case where there is not an income amount from a property which can cover the entire amount of the purchase amount, then the transfer-amount-calculation module 214 compares a plurality of income amounts from properties and determines whether or not they have the same house-rent transfer date (step 1825).

In a case where they do not have the same house-rent transfer date (“No” in step 1825), the transfer-amount-calculation module 214 selects an asset management company for transferring the purchase amount, in the order from an asset management company having the earliest house-rent transfer day (step 1830).

In a case where they have the same house-rent transfer date (“Yes” in step 1825), the transfer-amount-calculation module 214 compares a plurality of income amounts from properties and determines whether or not they have the same house-rent transfer amount (step 1835).

In a case where they do not have the same house-rent transfer amount (“No” in step 1835), the transfer-amount-calculation module 214 selects an asset management company for transferring the purchase amount, in the order from an asset management company having the largest house-rent transfer amount in total (step 1840).

In a case where they have the same house-rent transfer amount (“Yes” in step 1835), the transfer-amount-calculation module 214 selects an asset management company for transferring the purchase amount, in the order from an asset management company having the largest number of managed properties in total (step 1845).

Thereafter, the transfer-amount-calculation module 214 calculates the investment-account transfer amount for each asset management company (step 1850), and notifies the investment-account transfer amount to each asset management company terminal 103 of each asset management company (step 1860).

For example, it is assumed that a purchase amount of an investment product to be purchased is 200 thousand yen (or Japanese yen). Also, it is assumed that the house-rent transfer amount and the house-rent transfer day of each asset management company are given as follows:
Asset management company A: 80 thousand yen on January 10.
Asset management company B: 100 thousand yen on January 20.
Asset management company C: 90 thousand yen on January 20.

In this example, the asset management company A having the earliest house-rent transfer date is selected, and the first priority is given thereto. Next, since the asset management companies B and C have the same transfer date, the asset management company B having a larger transfer amount is selected, and the second priority is given thereto. Finally, the third priority is given to the last remaining asset management company C.

The transfer-amount-calculation module 214 calculates the investment-account transfer amount for each asset management company in this order. As a result, the following amounts are obtained.

The purchase amount: 120 thousand yen.

The asset management company A: 80 thousand yen (remaining of the purchase amount is 120 thousand yen).

The asset management company B: 100 thousand yen (remaining of the purchase amount is 20 thousand yen).

The asset management company C: 20 thousand yen (remaining of the purchase amount is 0 yen).

Here, the asset management company C determines the transfer amount in the following way: 20 thousand yen is transferred, from the house-rent transfer amount of 90 thousand yen, to the investment account and the remaining 70 thousand yen is transferred to the owner's ordinary account. Then, the asset management company C notifies the information to the asset management company terminal 103 of the asset management company C.

The transfer-amount-calculation module 214 determines whether or not the purchase amounts for all the investment products are processed (step 1865). In a case where there left an amount of money that has not been processed, the transfer-amount-calculation module 214 returns to the step 1815.

FIG. 19 depicts an example of a processing flow for calculating a transfer amount to an investment account 1900.

The transfer-amount-calculation module 214 executes the processing flow 1900 when there is an income amount from a property which can cover all the purchase amount of the investment product.

The transfer-amount-calculation module 214 determines whether or not there are a plurality of asset management companies, each of which has an income amount from a property(s) which can cover all the purchase amount of the investment product (step 1910). If there are not a plurality of asset management companies, but there is only one asset management company, then the asset management company is selected as the asset management company to which the purchase amount is transferred (step 1920).

If there are a plurality of asset management companies, each of which has an income amount from a property(s) which can cover the entire amount of the purchase amount of the investment product (“Yes” in step 1910), then, it determines whether or not they have the same house-rent transfer date from each asset management company (step 1930).

If they do not have the same house-rent transfer date (“No” in step 1930), the transfer-amount-calculation module 214 selects an asset management company having the earliest house-rent transfer date, as the asset management company for transferring the purchase amount (step 1940).

If they have the same house-rent transfer date (“Yes” in step 1930), the asset management company managing the largest number of houses (or rooms) in total is selected as the asset management company for transferring the purchase amount (step 1950).

Thereafter, the transfer-amount-calculation module 214 notifies the investment-account transfer amount to the asset management company terminal 103 of the selected asset management company.

With referring to the processing flows depicted in FIGS. 18, 19, an amount of money to be transferred to an investment account, and an asset management company are determined according to the following rules:

Rule 1: These are determined based on a transfer amount of a product having the earliest investment execution day (or date for executing the investment).

Rule 2: The transfer process to the investment account is applied, while giving priorities to an asset management company which has an income amount from a property which can cover the entire transfer amount to the investment account.

Rule 3: The transfer process to the investment account is applied, while giving priorities to an asset management company which has the late investment execution day (or withdrawal date) and the late transfer date.

Rule 4: If the income amount from the property and the transfer date are the same, then, the transfer process to the investment account is applied, while giving priorities to an asset management company having a larger transfer amount in total.

Rule 5: The transfer process to the investment account is applied, while giving priorities to an asset management company having a larger number of managed houses (or rooms) in total.

For example, the followings are examples for calculating the transfer destination and the amount of money.

Case 1: There are management companies which are capable of transferring an entire amount for the investment account.

Owner A: A periodic investment amount is 100 thousand yen and the investment execution day is 26th of each month.

Management company B: An income amount from a property is 200 thousand yen and the transfer day is 24th of each month.

Management company C: An income amount from a property is 50 thousand yen and the transfer day is 25th of each month.

In this case:
The management company B: 100 thousand yen in the ordinary account and 100 thousand yen in the investment account.

The management company C: 50 thousand yen in the ordinary account.

Case 2: Conditions are the same, but except for the transfer dates.

Owner A: A periodic investment amount is 100 thousand yen and the investment execution day is 26th of each month.

Management company B: An income amount from a property is 200 thousand yen and the transfer day is 25th of each month.

Management company C: An income amount from a property of 200 thousand yen and the transfer day is 20th of each month.

In this case:
The management company B: 50 thousand yen in the ordinary account.

The management company C: 100 thousand yen in the ordinary account and 100 thousand yen in the investment account.

Case 3

Owner A: A periodic investment amount is 100 thousand yen and the investment execution day is 26th of each month.

Management company B: An income amount from a property is 50 thousand yen and the transfer day is 25th of each month.

Management company C: An income amount from a property is 20 thousand yen and the transfer day is 25th of each month.

Management company D: An income amount from a property is 40 thousand yen and the transfer day is 24th of each month.

Management company E: An income amount from a property is 20 thousand yen and the transfer day is 24th of each month.

In this case:
The management company B: 50 thousand yen in the investment account.
The management company C: 20 thousand yen in the investment account.
The management company D: 30 thousand yen in the investment account and 10 thousand yen in the ordinary account.

The management company E: 20 thousand yen in the investment account.

FIG. 20 depicts a processing flow for calculating an investment score 2000.

The investment score is calculated according to information on a property owned by an owner and information on an income amount obtained from the property. The investment score indicates an owner's adaptability on the investment. Basically, as the profitability of the property owned by the owner becomes higher, the score becomes higher. Also, as the number of purchases of investment properties becomes higher, the score becomes higher to indicate that the owner is accustomed to the investment.

The investment-score-calculation module 215 performs a scoring based on a property(s) owned by an owner (step 2010). This scoring is referred to as a property score.

The investment-score-calculation module 215 obtains property information such as the years after construction, the address, the property type (such as a detached house, an apartment, or a condominium), the number of elevators, the number of parking spaces, the number of rooms and the like from the property DB 2400 and the property facility DB 2500 of the management server 101.

The investment-score-calculation module 215 calculates the property score based on the obtained information, for example, according to the following equation.

The property score=α×A+β×B+γ×V+δ×D+ε×R+ζ×Z

Where a+(3+γ+6+6+=1,
A=100−|Optimum years after construction−Years after construction|,
B=Location score (0-100),
C=Property type score (0-100),
D=100−MAX ((Number of floors/Number of elevators−10), 0),
E=100−(Number of rooms−Number of parking spaces),
Z=Facility score (0-100).

MAX (A, B): the highest value of any of A and B is obtained.

α, β, γ, δ, ε, ζ: a coefficient (0-1) for each calculation element.

A: A score about years after construction. Basically, as the numeric value of the years after construction becomes smaller, the score becomes larger. However, depending on regions, as the numeric value of the years after construction becomes larger, the score becomes larger. Accordingly, the optimum numeric value of the years after construction is defined for each area, and the score is determined by the difference from that numeric value.

B: A location score. It varies depending on the address. It is calculated based on the services offered by the peripheral facilities and the distance from the station (the information on the peripheral facilities and the distance from the station may be obtained by using an external map information API, etc.).

C: A score depending on the property type. Basically, the score is set according to the property type for each location (or area), for example, there are a case where the score of a detached house is high depending on the region, a case where the score of a condominium is high depending on the region, and a case where the score of an apartment is not so low depending on the region. Accordingly, the score is calculated considering the address of the property information and the property type.

D: If the numeric value obtained from the equation of (Number of floors/Number of elevators) is equal to or less that 10, the score is 100 points, and if the numeric value obtained from that equation exceeds 10, the score is decreased from 100 points.

E: A score for determining whether or not parking spaces are sufficient with regard to the number of rooms.

Z: It is calculated according to the following equation:

(Each facility from the property facility DB2500×Weighting)/(Number of the facility from the property facility DB2500).

The investment-score-calculation module 215 performs a scoring based on a content of a property owned by an owner (step 2020). This scoring is referred to as a room score.

The investment-score-calculation module 215 obtains room information such as the number of floors, the area, the room division, the floor layout, the number of lavatories or toilets, the number of baths, the room type, and the like from the room DB 2600 and the room facility DB 2700 of the management server 101.

For example, the investment-score-calculation module 215 calculates a room score based on the obtained information according to the following equation.

Roomscore=α×A+β+B+γ×C+δ×D+ε×E+ζ×Z
Where α+β+γ+δ+ε+ζ=1,
A=100-|Top floor−Number of floors|(In a case of 1 floor, it is set to 0),
B=A score of area (0-100),
C=A score of the number of rooms, room type (0-100),
D=100−(Number of rooms (excluding a living room)/Number of lavatories−1) (If a lavatory is not provided, it is set to 0),
E=A score of the number of baths (0 or 50 or 100),
Z=A score of facility (0-100).
A: A score of the number of floors. Basically, as the number of floors becomes larger, the score becomes higher.
B: A score of area. As the area becomes larger, the score becomes higher.
C: A score of the number of rooms. As the number becomes larger, the score becomes higher. It also relates to a room type score, and the score is higher when a living room and a kitchen are separated.
D: A score of the number of lavatories. As the rate of lavatories becomes larger with regard to the number of rooms, the score becomes higher.
E: A score of the number of baths. If the number is 0, the score is 0. If the number is 1, the score is 50. And if the number is equal to or larger than 2, the score is 100.
Z: It is calculated according to the following equation:

(Each facility from the room facility DB2700)×Weighting/(Number of facilities from the property facility DB2500).

The investment-score-calculation module 215 performs a scoring based on the investment in real estate which had been performed in past times (step 2030). This scoring is referred to as an owned property score.

The investment-score-calculation module 215 obtains information such as the owned property(s), the unit price of room, the rate of yield of the owned property, the cash flow of the owned property, and the like from the property transaction DB 2800 and cash flow DB 3100 of the management server 101.

For example, the investment-score-calculation module 215 calculates a room score based on the obtained information, according to the following equation.

Roomscore=α×A+β×B+γ×C+δ×D
Where α+β+γ+δ=1,
A=A score of a purchase amount of a property(s) in total (0-100),
B=A score of (Average property/Unit price of a room) (0-100),
C=A score of monthly income amount in total (0-100),
D=A score of average rate of yield (0-100).

A: A score of a purchase amount of a property(s) in total. If the amount is less than 50 million yen, the score is 30. If the amount of money is in a range of from 50 million yen to 100 million yen, the score is 50. If the amount is in a range of from 100 million yen to 300 million yen, the score is 70. If the amount is in a range of from 300 million yen to 500 million yen, the score is 90. And, if the amount is larger than 500 million yen, the score is 100.

B: A score obtained from the equation of (Average property/Unit price of a room). If the amount of money is less than 30 million yen, the score is 30. If the amount is equal to or larger than 30 million yen, the score is 50. If the amount is equal to or larger than 50 million yen, the score is 70. And if the amount is equal to or larger than 100 million yen, the score is 100.

C: A score of the monthly income amount in total. If the income amount is less than 300 thousand yen, the score is 30. If the income amount is in a range of from 300 thousand yen to 500 thousand yen, the score is 50. If the income amount is in a range of from 500 thousand yen to 1 million yen, the score is 70. And if the income amount is larger than 1 million yen, the score is 100.

D: A score of the average rate of yield. If the rate is less than 3%, the score is 50. If the rate is in a range of from 3% to 4%, the score is 70. And if the rate is larger than 4%, the score is 100.

The investment-score-calculation module 215 performs a scoring based on an investment(s) excluding real estate which had been performed in past times (step 2040). This scoring is referred to as a non-real estate investment score.

The investment-score-calculation module 215 obtains investment information in past times from the investment record DB or cooperation destinations (or partner companies) through the API or the data cooperation.

For example, the investment-score-calculation module 215 calculates a room score based on the obtained investment information, according to the following equation.

Roomscore=α×A+β×B+γ×C+δ×+ε×E

Where a+(3+γ+6+=1,
A=A score of number of investment (0-100),
B=A score of investment amount in total (0-100),
C=A returns in total (0-100),
D=An average rate of yield (0-100),
E=A balance in the investment account (0-100).

A: A score is given from a multiplication of the number of investments by a coefficient (the full score is 100 points).

B: A score is given from a multiplication of the investment amount in total by a coefficient (the full score is 100 points).

C: A score is given from a multiplication of the returns in total by a coefficient (the full score is 100 points).

D: If the rate is smaller than 3%, the score is 50. If the rate is in a range of from 3% to 4%, the score is 50. And if the rate is bigger than 4%, the score is 100.

E: A score is given from a multiplication of the balance in the investment account by a coefficient (the full score is 100 points).

The investment-score-calculation module 215 calculates the investment score in five stages by summing the numerical values of the above-mentioned each scoring (step 2050).

For example, the following thresholds are used for the five-step investment score.
Investment score 5: equal to or larger than 250 points.
Investment score 4: equal to or larger than 200 points.
Investment score 3: equal to or larger than 150 points.
Investment score 2: equal to or larger than 100 points.
Investment score 1: smaller than 100 points.

The calculated investment score is displayed on the asset management screen 600 for investment of the user terminal 102, for example, as depicted in FIG. 6.

The investable-amount-calculation module 212 is capable of changing the investable amount based on the investment score. For example, the investable-amount-calculation module 212 increases the investable amount from the ordinary amount in a case when the investment score is good (for example, the investment score is equal to or larger than 4).

Also, the user-investment-processing module 312 of the user terminal 102 may not display the available amount 604 from house-rent in advance (see FIG. 6) in a case when the numeric value of the investment score is not good (for example, the investment score is any number in a range of from 1 to 4). Also, the user-investment-processing module 312 of the user terminal 102 may display the available amount 604 from house-rent in advance in a case when the numeric value of the investment score is good (for example, the investment score is equal to or larger than 4). Accordingly, it becomes possible to make an investment by using the house-rent in advance.

Also, the investable-amount-calculation module 212 may change the available amount 604 from the house-rent in advance to increase the amount of money when the numeric value of the investment score is good.

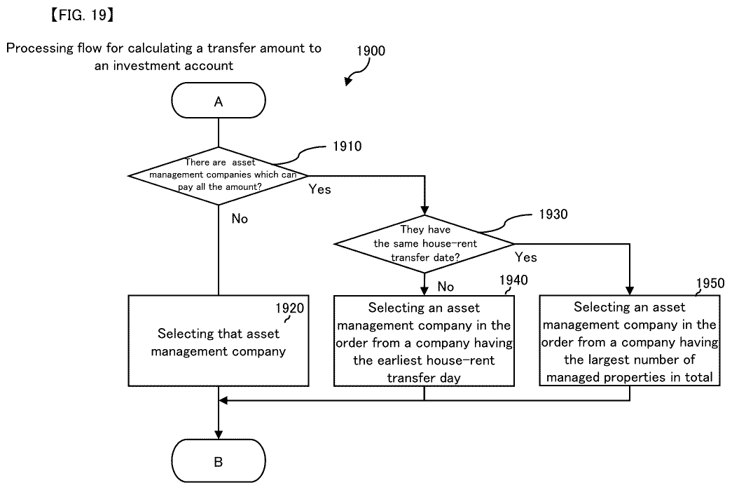

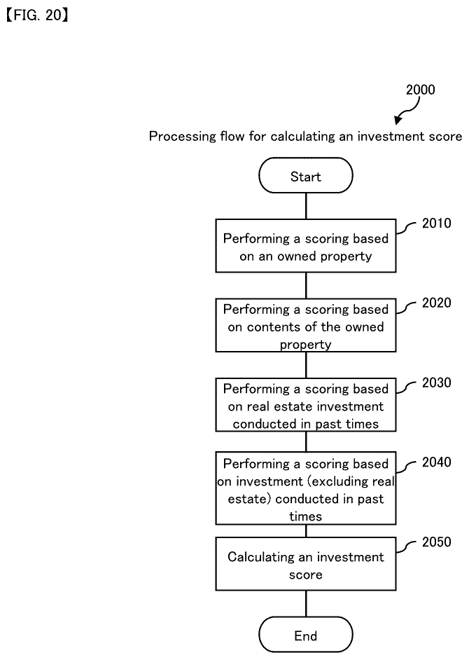

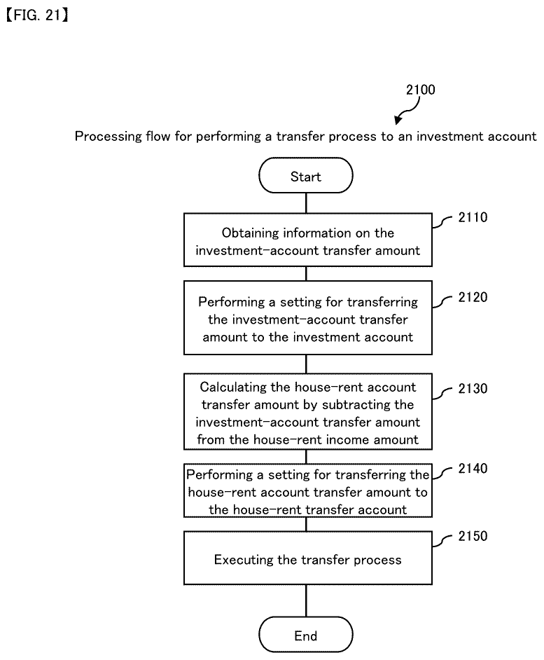

FIG. 21 depicts an example of a processing flow for performing a transfer process to an investment account 2100.

The processing flow for performing a transfer process to an investment account 2100 is a processing flow in which the investment management company performs the transfer process based on the investment-account transfer amount which is notified from the management server 101.

The asset-management-company-management module 411 of the asset management company terminal 103 obtains information on the investment-account transfer amount, from the management server 101 (step 2110).

The asset-management-company-management module 411 executes a setting for performing the transfer process of the investment-account transfer amount which is described in the notified information about the investment-account transfer amount, to the investment account (for example, the investment account 1208 depicted in FIG. 12) (step 2120).

The asset-management-company-management module 411 calculates the house-rent account transfer amount (or an amount of money to be transferred to an account for the house-rent) obtained by deducting the investment-account transfer amount from the house-rent income amount (step 2130).

The asset-management-company-management module 411 executes the transfer setting for transferring the calculated house-rent account transfer amount to the house-rent transfer account (for example, the ordinary account 1207 depicted in FIG. 12) (step 2140).

The asset-management-company-management module 411 executes the transfer process based on the transfer setting with regard to the set investment account and the transfer setting with regard to the house-rent transfer account (step 2150).

In the present example, it is explained that the management-server-investment-management module 216 of the management server 101 is configured to cooperate with the profit-information-management module 211, the investable-amount-calculation module 212, the investment-product-management module 213, the transfer-amount-calculation module 214, and the investment-score-calculation module 215. However, these processes may be performed by the user-investment-processing module 312 of the user terminal 102.

In this case, the user-investment-processing module 312 of the user terminal 102 executes the similar functions as those of the management-server-investment-management module 216, and the sub-modules such as the profit-information-display module, the investable-amount-display module, the investment-product-display module, the transfer-amount-display module, and the investment-score-display module of the user terminal 102 respectively execute the processes corresponding to those of the profit-information-management module 211, the investable-amount-calculation module 212, the investment-product-management module 213, the transfer-amount-calculation module 214, and the investment-score-calculation module 215 of the management server 101.

That is, in the case of realizing the above-mentioned example in the user terminal 102, it may be realized by a property management program for causing the user terminal to function as: the profit-information-display means for displaying the house-rent income amount based on the information on the house-rent income amount sent from the asset management company terminal used by the asset management company; the investable-amount-display means for displaying the investable amount which is calculated based on the information on the house-rent income amount; and the investment-product-display means for displaying the investment products which are selected based on the investable amount to accept a selection of an investment product which is desired to be purchased from among the displayed investment products

Also, it may be realized by a property management program for causing the user terminal to function as: the transfer-amount-display means for displaying the investment-account transfer amount which is calculated based on the information on the selected investment product to be purchased; and the investment-score-display means for displaying the investment score which is calculated based on the information on the property owned by the user and the information on the income amount obtained from the property.

The present invention is not limited to the above-mentioned examples, and various modifications may be included. For example, the above-mentioned examples have been described in detail, for the purpose of illustrating the present invention clearly, and are not necessarily limited to those having all the above-described configurations. Also, it is possible to replace a part of a configuration of an example with a configuration of another example. Also, it is possible to add a configuration of an example to a configuration of another example. Further, it is possible to add, delete, and/or replace of another configuration with regard to a part of a configuration of each example.

A part or all of the above-mentioned respective configurations, functions, processing units, and processing means, etc., may be implemented in hardware, for example, by designing an integrated circuit or the like. Also, each of the above-mentioned configurations, functions, etc., may be implemented in software, for example, by using a program whereby a processor interprets and executes each function thereof. Information such as programs, tables, files, etc., for realizing the respective functions may be stored in a storage device such as a memory, a hard disk, or an SSD (or Solid State Drive), etc., or in a storage medium such as an IC card, an SD card, or a DVD, etc.

Also, control lines and information lines which are considered to be necessary for explanation are depicted in the figures. However, not all the control lines and the information lines are always depicted in the figures for explaining the product. In practice, almost all of the configurations may be considered to be connected to each other.

It is contemplated that the above-described examples discloses the configurations described in the claims, at least.

Major Terms Used are as Follows:
1 . . . Asset management system, 101 . . . Management server, 102 . . . User terminal, 103 . . . Asset management company terminal, 211 . . . Profit-information-management module, 212 . . . Investable-amount-calculation module, 213 . . . Investment-product-management module, 214 . . . Transfer-amount-calculation module, 215 . . . Investment-score-calculation module, 311 . . . Registration-processing module, 312 . . . User-investment-processing module, 411 . . . Asset-management-company-management module.

What is claimed is:

1. A management server, comprising:
a profit-information-management means for obtaining information on a house-rent income amount from an asset management company terminal used by an asset management company;
an investable-amount-calculation means for calculating an investable amount based on the information on the house-rent income amount;
an investment-product-management means for selecting an investment product based on the investable amount; and
an investment-management means for outputting the selected investment product to a user terminal used by a user.

2. The management server according to claim 1, further comprising a transfer-amount-calculation means for receiving information on the investment product to be purchased from the user terminal, and for calculating an investment-account transfer amount based on the information on the investment product to be purchased.

3. The management server according to claim 2, wherein the transfer-amount-calculation means selects one of asset management company terminals to which information on the investment-account transfer amount is sent, based on the information on a plurality of the house-rent income amounts, which are received from a plurality of the asset management company terminals, and based on the information on the investment product to be purchased, which is received from the user terminal.

4. The management server according to claim 3, wherein the transfer-amount-calculation means selects an asset management company terminal as the one of the asset management company terminals to which the information on the investment-account transfer amount is sent, wherein the asset management company terminal has sent the information on the house-rent income amount that can cover an entire amount of money of the investment product which corresponds to the information on the investment product to be purchased.

5. The management server according to claim 2, wherein the investment-management means sends the information on the investment-account transfer amount to the asset management company terminal.

6. The management server according to claim 2, wherein the asset management company transfers a part of a house-rent income amount to be transferred to the user, to an investment account of the user, wherein the part corresponds to the sent information on the investment-account transfer amount.

7. The management server according to claim 2, wherein the investment-management means outputs, to the user terminal, the investment-account transfer amount, and an amount obtained by deducting the investment-account transfer amount from the house-rent income amount.

8. The management server according to claim 1, further comprising an investment-score-calculation means for calculating an investment score based on information on a property owned by the user and on information on a profit obtained from the property.

9. The management server according to claim 8, wherein the investable-amount-calculation means changes the investable amount based on the investment score.

10. The management server according to claim 1, wherein the profit-information-management means calculates a collected house-rent income amount in total based on the information on a plurality of the house-rent income amount, which are received from a plurality of the asset management company terminals, and
wherein the investment-management means outputs the information on the collected house-rent income amount, to the user terminal.

11. The management server according to claim 1, wherein the investment-product-management means selects an investment product based on information on a property owned by the user.

12. The management server according to claim 1, wherein the investment-product-management means selects an investment product based on information on the investment made by the owner in past times.

13. The management server according to claim 1, wherein the investment-product-management means selects an investment product based on a content of a chat sent from the user terminal.

14. A property management program for causing a user terminal to function as:
a profit-information-display means for displaying a house-rent income amount based on information on a house-rent income amount, which is sent from an asset management company terminal used by an asset management company;
an investable-amount-display means for displaying an investable amount that is calculated based on the information on the house-rent income amount; and
an investment-product-display means for displaying one or a plurality of investment products that are selected based on the investable amount, and for receiving a selection of an investment product to be purchased from among the displayed one or a plurality of the investment products.

15. The property management program according to claim 14, further causing the user terminal to function as
a transfer-amount-display means for displaying an investment-account transfer amount that is calculated based on information on the selected investment product to be purchased.

16. The property management program according to claim 14, wherein the transfer-amount-display means simultaneously displays the investment-account transfer amount, and an amount obtained by deducting the investment-account transfer amount from the house-rent income amount.

17. The property management program according to claim 14, further causing the user terminal to function as
an investment-score-display means for displaying an investment score that is calculated based on information on a property owned by the user and on information on a profit obtained from the property.

18. A property management method, comprising:
receiving information on a house-rent income amount from an asset management company terminal used by an asset management company;
calculating an investable amount based on the information on the house-rent income amount;
selecting of an investment product based on the investable amount; and
outputting the selected investment product to a user terminal used by a user.

19. The property management method according to claim 18, further comprising:
receiving information on the investment product to be purchased, from the user terminal, and
calculating an investment-account transfer amount based on the information on the investment product to be purchased.

20. The property management method according to claim 18, further comprising:
transferring a part of a house-rent income amount to be transferred to the user, to an investment account of the user, wherein the part corresponds to the sent information on the investment-account transfer amount.
